(19) United States
(12) Patent Application Publication
(10) Pub. No.: US 2023/0138458 A1
(43) Pub. Date: May 4, 2023

(54) MACHINE LEARNING SYSTEM AND METHOD

(71) Applicant: INSTITUTE FOR INFORMATION INDUSTRY, TAIPEI (TW)

(72) Inventors: Te-En Wei, Taipei (TW); Kun Wei Lee, Taipei (TW); Shin-Ying Huang, Taipei (TW); Hsiao-Hsien Chang, Taipei (TW); Jain-Shing Wu, Taipei (TW)

(21) Appl. No.: 17/456,560

(22) Filed: Nov. 24, 2021

(30) Foreign Application Priority Data
Nov. 2, 2021 (TW) 110140836

(51) Int. Cl. H04L 29/06; G06N 20/00

(52) U.S. Cl. CPC H04L 63/1416; G06N 20/00

(57) ABSTRACT

A machine learning system and method are provided. The machine learning system includes a plurality of client apparatuses, and the client apparatuses include a first client apparatus and one or more second client apparatuses. The first client apparatus transmits a model update request to the one or more second client apparatuses, and the model update request corresponds to a malware type. The first client apparatus receives a second local model corresponding to each of the one or more second client apparatuses from each of the one or more second client apparatuses. The first client apparatus generates a plurality of node sequences based on a first local model and each of the second local models. The first client apparatus merges the first local model and each of the second local models based on the node sequences to generate a local model set.

### CROSS-REFERENCE TO RELATED APPLICATION

This application claims priority to Taiwan Application Serial Number 110140836, filed Nov. 2, 2021, which is herein incorporated by reference in its entirety.

### BACKGROUND

### Field of Invention

The present invention relates to a machine learning system and method. More particularly, the present invention relates to a machine learning system and method that integrate models of various client apparatuses to achieve the sharing of the models.

### Description of Related Art

In recent years, the information security detection and prevention models maintained by enterprises or departments themselves are no longer sufficient to cope with the types and quantities of rapidly developing malware. Therefore, it is necessary to combine information security detection and prevention models in different heterogeneous fields to improve the overall effectiveness of the joint defense. At the same time, it is also necessary to take into account the privacy of data protection.

Accordingly, a mechanism is needed to enable the information security detection and prevention models to be trained separately on client terminals, and to feedback the information security detection and prevention models trained in different fields to a certain terminal to integrate the models and expert knowledge. In addition, the mechanism is needed to feedback the integration results to each terminal to achieve the purpose of safety and efficient sharing of the information security detection and prevention models and expert knowledge.

Accordingly, there is an urgent need for a technology that can integrate the models of various client apparatuses.

### SUMMARY

An objective of the present invention is to provide a machine learning system. The machine learning system comprises a plurality of client apparatuses, and the client apparatuses are communicated with an encrypted network. The client apparatuses comprise a first client apparatus and one or more second client apparatuses. The first client apparatus stores a first local model. Each of the one or more second client apparatuses stores a second local model, and the first local model and each of the second local models correspond to a malware type. The first client apparatus transmits a model update request to the one or more second client apparatuses, wherein the model update request corresponds to the malware type. The first client apparatus receives the second local model corresponding to each of the one or more second client apparatuses from each of the one or more second client apparatuses. The first client apparatus generates a plurality of node sequences based on the first local model and each of the second local models. The first client apparatus merges the first local model and each of the second local models based on the node sequences to generate a local model set.

Another objective of the present invention is to provide a machine learning method, which is adapted for use in a machine learning system. The machine learning system comprises a plurality of client apparatuses, the client apparatuses are communicated with an encrypted network, and the client apparatuses comprise a first client apparatus and one or more second client apparatuses. The first client apparatus stores a first local model, each of the one or more second client apparatuses stores a second local model, and the first local model and each of the second local models correspond to a malware type. The machine learning method is performed by the first client apparatus and comprises following steps: receiving the second local model corresponding to each of the one or more second client apparatuses from each of the one or more second client apparatuses based on a model update request, wherein the model update request corresponds to the malware type; generating a plurality of node sequences based on the first local model and each of the second local models; and merging the first local model and each of the second local models based on the node sequences to generate a local model set.

According to the above descriptions, the machine learning technology (at least includes the system and the method) provided by the present invention transmits a model update request to other client apparatuses in the encrypted network, and receives the local model corresponding to each of the client apparatuses from the client apparatuses. Next, the machine learning technology provided by the present invention generates a plurality of node sequences based on the local models (e.g., the first local model and the second local model). Finally, the machine learning technology provided by the present invention merges the local model to generate a local model set based on the node sequences. The machine learning technology provided by the present invention uses a federated learning sharing model framework to share the learning experience of the local models, and strengthens learning through expert knowledge, integrates the local models of each client apparatus, and enhances the effect of regional joint defense.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view depicting a machine learning system of the first embodiment;

FIG. 2 is a schematic view depicting a client apparatus of the first embodiment;

FIG. 3A is a schematic view depicting a model of the first embodiment;

FIG. 3B is a schematic view depicting a node sequence of the first embodiment; and

FIG. 4 is a partial flowchart depicting a machine learning method of the second embodiment.

### DETAILED DESCRIPTION

In the following description, a machine learning and method according to the present invention will be explained with reference to embodiments thereof. However, these embodiments are not intended to limit the present invention to any environment, applications, or implementations described in these embodiments. Therefore, description of these embodiments is only for purpose of illustration rather than to limit the present invention. It shall be appreciated that, in the following embodiments and the attached drawings, elements unrelated to the present invention are omitted from depiction. In addition, dimensions of individual elements and dimensional relationships among individual elements in the attached drawings are provided only for illustration but not to limit the scope of the present invention.

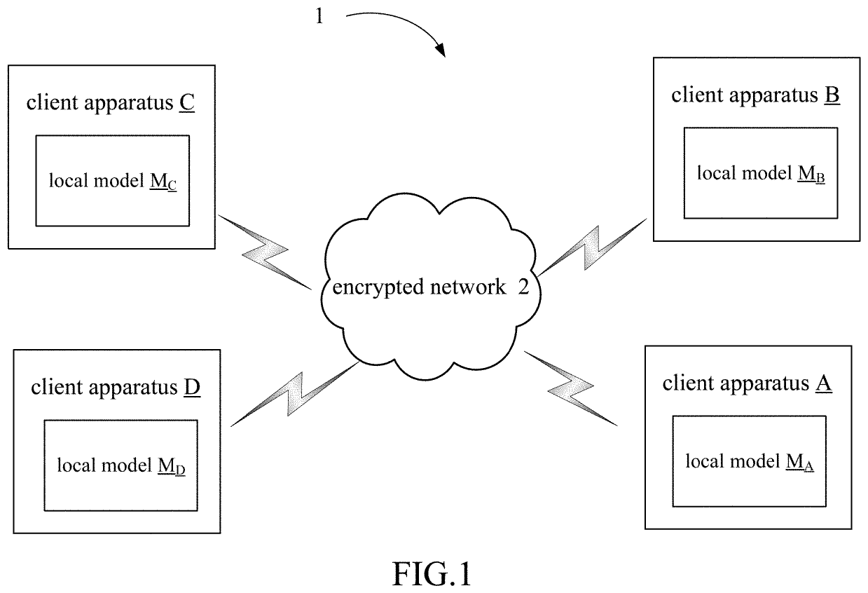

First, the application scenario of the present embodiment will be explained, and a schematic view is depicted in FIG. 1. As shown in FIG. 1, the machine learning system 1 comprises a plurality of client apparatuses A, B, C, and D. In this scenario, the client apparatuses A, B, C, and D are communicated with the encrypted network 2, and the client apparatuses A, B, C, and D comprise local models M_{A}, M_{B}, M_{C}, and M_{D} respectively that correspond to at least a malware type (e.g., information security and detection models used to detect Trojan horse malware).

It shall be appreciated that the client apparatuses A, B, C, and D can be, for example, information security servers of different enterprises or different departments. The client apparatuses A, B, C, and D collect local data in their respective fields and carry out the local model training, and share local model training results from different fields through the encrypted network 2 (e.g., the models and the model-related parameters). Therefore, the privacy of local data can be preserved and the local data will not be shared.

It shall be appreciated that the present invention does not limit the number of client apparatuses in the machine learning system 1 and the number of local models included in each client apparatus (i.e., each client apparatus can contain a plurality of local models that correspond to a plurality of types of malware). For ease of following descriptions, the following will take each client apparatus comprising a local model as an example. Those of ordinary skill in the art shall appreciate the corresponding operations of the client apparatus that comprises multiple local models based on these descriptions. Therefore, the details will not be repeated herein.

The specific operations of the first embodiment will be described in detail in the following paragraphs, please refer to FIG. 1. For ease of description, the following paragraphs will take the client apparatus A among the client apparatuses A, B, C, and D as the main apparatus (i.e., the first client device) that is leading the integrating operations of the local models. It shall be appreciated that, in other embodiments, the client apparatuses B, C, or D (i.e., the one or more second client apparatuses) can also implement the same integrating operations. Therefore, the details will not be repeated herein.

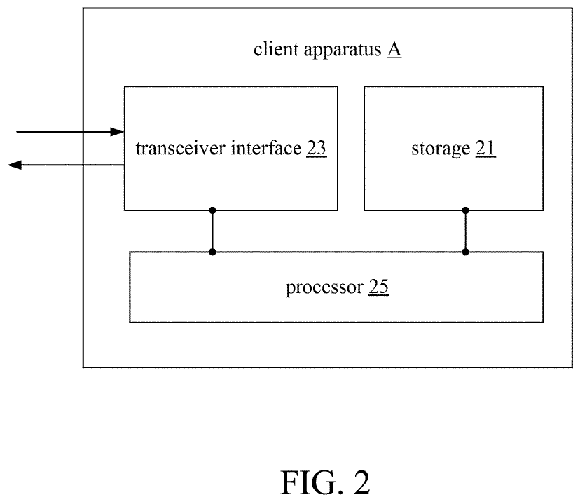

The schematic view of the structure of the client apparatus in the first embodiment of the present invention is depicted in FIG. 2 (taking client apparatus A as an example). The client apparatus A comprises a storage 21, a transceiver interface 23 and a processor 25, wherein the processor 25 is electrically connected to the storage 21 and the transceiver interface 23. The storage 21 may be a memory, a Universal Serial Bus (USB) disk, a hard disk, a Compact Disk (CD), a mobile disk, or any other storage medium or circuit known to those of ordinary skill in the art and having the same functionality. The transceiver interface 23 is an interface capable of receiving and transmitting data or other interfaces capable of receiving and transmitting data and known to those of ordinary skill in the art. The transceiver interface 23 can receive data from sources such as external apparatuses, external web pages, external applications, and so on. The processor 25 may be any of various processors, Central Processing Units (CPUs), microprocessors, digital signal processors or other computing apparatuses known to those of ordinary skill in the art.

In the present embodiment, as shown in FIG. 1, the client apparatuses A, B, C, and D comprise local models M_{A}, M_{B}, M_{C}, and M_{D} respectively that correspond to a malware type.

First, in the present embodiment, the client apparatus A determines that the stored local model M_{A} needs to be updated. Therefore, the client apparatus A transmits a model update request to the client apparatuses B, C, and D in the encrypted network 2. Specifically, the client apparatus A (or referred to as the first client apparatus) transmits a model update request to the client apparatuses B, C, and D (or referred to as the second client apparatus), wherein the model update request corresponds to the malware type.

It shall be appreciated that the timing of the model update request can be determined by, for example, the client apparatus A or an information security personnel with domain knowledge to determine that the current local model of client apparatus A is insufficient to predict the malware, and thus the local model needs to be updated. For example, when the local model version is outdated or a new type of malware appears, it may cause the current local model of the client apparatus A to predict the malware with low accuracy.

Next, the client apparatus A decomposes the characteristic determination rules in the local models M_{A}, M_{B}, M_{C}, and M_{D} to generate a plurality of node sequences, the node sequences will be used in subsequent merging operations. Specifically, the client apparatus A generates a plurality of node sequences (NS) based on the local models (i.e., the local models M_{B}, M_{C}, and M_{D}, or referred to as the second client apparatus) and the first local model (i.e., the local model M_{A}). It shall be appreciated that, in the present embodiment, the client apparatus A transmits a model update request to the client apparatuses B, C, and D in the encrypted network 2. In this case, the client apparatus A is regarded as the first client apparatus (stored with the first local model), and other apparatuses belong to the second client apparatus (stored with the second local model). In other cases, for example, if the client apparatus C transmits a model update request to the client apparatuses A, B, and D in the encrypted network 2, the client apparatus C is regarded as the first client apparatus at this time, and other apparatuses belong to the second client apparatus.

It shall be appreciated that the local models M_{A}, M_{B}, M_{C}, and M_{D} can be composed of a tree-based decision tree, and the decision tree is composed of a plurality of determination rules. Specifically, since each node has a determination of the characteristic determination value in the tree structure, each node and its characteristic determination value in the local model can be split into a plurality of node sequences.

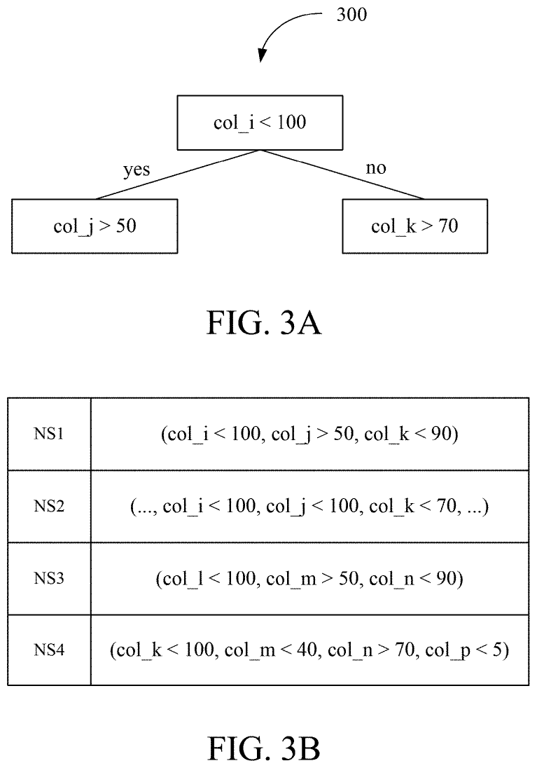

For ease of understanding, a practical example is taken as an example, as shown in FIG. 3A. FIG. 3A illustrates a model 300 having a two-level tree structure. The nodes in the first level contain the node item “col_i” and the characteristic determination value “col_i<100”, and the nodes in the second level contain the node items “col_j” and “col_k” and their corresponding characteristic determination value are “col_j>50” and “col_k>70”. Therefore, in this example, two node sequences “(col_i<100, col_j>50)” and “(col_i>=100, col_k<70)” can be generated based on the model 300.

It shall be appreciated that FIG. 3A is only for illustration but not to limit the scope of the present invention. Those of ordinary skill in the art shall appreciate the corresponding generating operations when the model has a more layered structure based on the above description. Therefore, the details will not be repeated herein.

Finally, the client apparatus A will determine which node sequences are similar, merge the similar node sequences, and generate a local model based on the merged node sequences to complete the merging of the local models M_{A}, M_{B}, M_{C}, and M_{D}. Specifically, the client apparatus A merges the first local model and each of the second local models based on the node sequences to generate a local model set.

In some embodiments, each of the node sequences comprises a plurality of node items and a characteristic determination value corresponding to each of the node items, and the client apparatus A further performs following operations for any two of the node sequences (i.e., select any two of the node sequences generated by the local models M_{A}, M_{B}, M_{C}, and M_{D}): comparing the node items corresponding to a first node sequence and a second node sequence to generate a similarity; merging the first node sequence and the second node sequence into a new node sequence when determining that the similarity is greater than a first default value, and adjusting the characteristic determination value corresponding to the new node sequence; and retaining the first node sequence and the second node sequence when determining that the similarity is less than a second default value.

In some embodiments, the client apparatus A further performs following operations: deleting at least a part of the node items in the first node sequence and the second node sequence when determining that the similarity is between the first default value and the second default value, merging the first node sequence and the second node sequence into the new node sequence, and adjusting the characteristic determination value corresponding to the new node sequence.

For example, the determination of the similarity includes three conditions: “similar” (i.e., the similarity is greater than the first default value (e.g., 0.9)), “not similar” (i.e., the similarity is less than the second default value (e.g., 0.1)) and “others” (i.e., the similarity is between the first default value and the second default value (e.g., between 0.9˜0.1)), the following paragraphs will illustrate in detail. In addition, the determination of the similarity can be operated through the well-known similarity algorithm, such as the sequence alignment algorithm. In some embodiments, since the length of the node sequences may be different, the client apparatus A can also determine the similarity by comparing parts of the node sequences.

For ease of understanding, please refer to FIG. 3B. FIG. 3B illustrates four different node sequences NS1, NS2, NS3, and NS4. Specifically, the node sequence NS1 is “(col_i<100, col_j>50, col_k<90)”, the node sequence NS2 is “( . . . , col_i<100, col_j<100, col_k<70, . . . )”, the node sequence NS3 is “(col_l<100, col_m>50, col_n<90)”, and the node sequence NS4 is “(col_k<100, col_m<40, col_n>70, col_p<5)”. For convenience of presentation, NS2 only lists part of the node sequence, and other layers that are not related to this comparison are omitted with “. . . ”.

The following will describe the case where the similarity is “similar”, please refer to the node sequences NS1 and NS2 in FIG. 3B. In this example, the client apparatus A compares the node items of the node sequence NS1 and NS2. Since the node items of NS1 and NS2 are both “col_i”, “col_j” and “col_k”, the client apparatus A determines the node sequence NS1 and NS2 have a very high degree of similarity (i.e., the corresponding determinations of certain node items in the local models are the same). Accordingly, the client apparatus A merges the node sequences NS1 and NS2, and adjusts the characteristic determination value of the common node items.

In the present embodiment, there are three methods to adjust the characteristic determination value after the merging process mentioned above, namely “union”, “intersection”, and “expert knowledge setting”, and different methods have different adjustment ranges for the characteristic determination value. In this example, if the node item “col_k” of NS1 and NS2 is merged by the “union”, the characteristic determination value corresponding to the merged node item “col_k” is “col_k<90” (i.e., select the larger range).

In this example, if the node item “col_j” of NS1 and NS2 is merged by the “intersection”, the characteristic determination value corresponding to the merged node item “col_j” is “50<col_j<100”.

In some embodiments, the client apparatus A may further change the characteristic determination value through the “expert knowledge setting” for nodes with lower feature importance. It shall be appreciated that the feature importance is the information generated during the training of the local model (e.g., the gain information), the feature importance is used to represent the degree of influence of the node on the model (i.e., the greater the importance of the feature, the greater the impact on the model's prediction results).

In this example, if the node item “col_i” of NS1 and NS2 is merged by the way of “expert knowledge setting”, the characteristic determination value corresponding to the merged node item “col_i” may be “col_i<80” (the characteristic determination value is col_i<100 before the merging process), because the expert determines that “col_i<80” can better improve the accuracy of the model. It shall be appreciated that the original characteristic determination value may be set higher or lower through the adjustment of the expert knowledge setting method, depending on the expert's judgment based on different types or experiences.

It shall be appreciated that in all merging operations of the present invention, the client apparatus A can adjust the characteristic determination value based on the aforementioned three methods (i.e., union, intersection, and expert knowledge setting) according to settings or requirements.

The following will explain the case where the similarity is “not similar”, please refer to the node sequences NS1 and NS3 in FIG. 3B. In this example, the client apparatus A compares the node items of the node sequence NS1 and NS3, because the node items of NS1 are “col_i”, “col_j”, and “col_k”, and the node items of NS3 are “col_l”, “col_m”, and “col_n”, the client apparatus A determines that the node items of the node sequence NS1 and NS3 are obviously different and the degree of similarity is extremely low (i.e., the corresponding determinations of certain node items in the local models are completely different). Accordingly, the client apparatus A retains the node sequences NS1 and NS3 and does not operate the merging operations.

The following will explain the case where the similarity is “other”, please refer to the node sequences NS1 and NS4 in FIG. 3B. In this example, the client apparatus A compares the node items of the node sequence NS1 and NS4, because the node items of NS1 are “col_i”, “col_j” and “col_k”, and the node items of NS4 are “col_k”, “col_m”, “col_n” and “col_p”, the client apparatus A determines that the node items of the node sequence NS1 and NS4 have only the node item “col_k” in common, and therefore determines the similarity degree to be “others”. Accordingly, the client apparatus A merges the node sequences NS1 and NS2, and adjusts the characteristic determination value of the common node items.

In some embodiments, the client apparatus A further performs following operations: sorting the node items of the first node sequence and the second node sequence based on a feature importance corresponding to each of the node items; deleting the node items that the feature importance is less than a third default value; and merging the first node sequence and the second node sequence into the new node sequence, and adjusting the characteristic determination value corresponding to the new node sequence.

Taking the node sequences NS1 and NS4 in FIG. 3B as an example, the client apparatus A first sorts the node sequences in NS3 and NS4 according to the feature importance, and the client apparatus A determines the feature importance of the node item “col_p” is less than the third default value. Accordingly, the client apparatus A deletes the node item “col_p” in NS4, and then continues the merge operation of NS3 and NS4. Since the client apparatus A deletes the node items whose feature importance is less than the default value, the problem of overfitting can be avoided.

In some embodiments, the client apparatus A further trains a new local model set based on the local data, and generates a new prediction result through the new local model set. Specifically, the client apparatus A first inputs a plurality of local data sets into the local model set to train the local model set. Then, the client apparatus A generates a prediction result based on the local model set, wherein the prediction result comprises a confidence interval (e.g., a confidence score).

For example, the prediction result can be generated by the client apparatus A through averaging or voting mechanism by counting the prediction results of each local model in the new local model set.

It shall be appreciated that the general information security server only uses the rules of the Intrusion Prevention System (IPS) and the Intrusion Detection System (IDS) to filter data. However, IDS/IPS rules can only predict basic forms of malware (e.g., when a file containing a file name of 123.txt, it is determined to be malware). The local models in the present invention can further analyze the behavior of the data operations and determine whether it is malware from the behavior of the data operations. Therefore, compared with the IDS/IPS rules, the local models in the present invention can further predict more possible malware behaviors.

In some implementations, in addition to generating events based on IDS/IPS rules, the client apparatus A also generates predictions for the events (i.e., to determine whether it is a malware) through the local model, compares the prediction result through the expert knowledge, and provides feedback to the local model. Therefore, the local model can further perform corrections according to the feedback.

In some embodiments, the client apparatus A may also determine the accuracy of the local model by calculating the ratio of false positives or false negatives. For example, if the proportion of false positives is too high, it may mean that the version of the local model is too old and the local model needs to be updated. If the proportion of false negatives is too high, it means that new types of malware may appear, and a new local model corresponding to the new types of malware needs to be generated.

In some embodiments, the client apparatus A further generates a local model corresponding to the new type of malware based on the local data. Specifically, the client apparatus A generates a new local model, wherein the new local model is configured to determine a new malware type.

In some embodiments, the client apparatus A further transmits the local model set to the client apparatuses B, C, and D in the encrypted network 2 to achieve the purpose of sharing the security information. Specifically, the client apparatus A transmits the local model set to the client apparatuses B, C, and D, so that the client apparatuses B, C, and D update the local models M_{B}, M_{C}, and M_{D} respectively based on the local model set.

In some embodiments, the client apparatuses B, C, and D can count the number of models that can detect malware types in the local model set received from the client apparatus A to determine whether a new local model needs to be added. For example, originally there are only models for detecting 10 types of malware. If the client apparatuses B, C, and D determine that the local model set received from client device A includes models that can detect 11 types of malware, then the client apparatuses B, C, and D may update their local model based on the newly added malware model.

According to the above descriptions, the machine learning system 1 provided by the present invention transmits a model update request to other client apparatuses in the encrypted network, and receives the local model corresponding to each of the client apparatuses from the client apparatuses. Next, the machine learning system 1 provided by the present invention generates a plurality of node sequences based on the local models (e.g., the first local model and the second local model). Finally, the machine learning system 1 provided by the present invention merges the local model to generate a local model set based on the node sequences. The machine learning technology provided by the present invention uses a federated learning sharing model framework to share the learning experience of the local models, and strengthens learning through expert knowledge, integrates the local models of each client apparatus, and enhances the effect of regional joint defense.

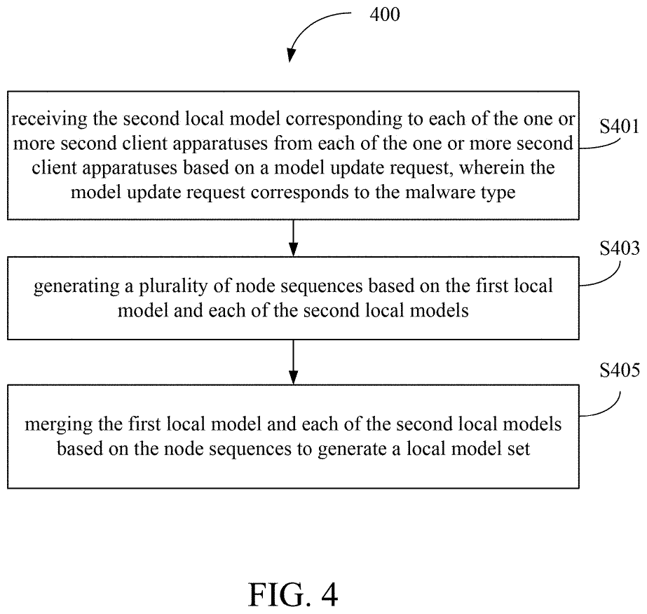

A second embodiment of the present invention is a machine learning method and a flowchart thereof is depicted in FIG. 4. The machine learning method 400 is adapted for use in a machine learning system, the machine learning system comprising a plurality of client apparatuses (e.g., the machine learning system 1 and the client apparatuses A, B, C, and D of the first embodiment). The client apparatuses are being configured to communicate with an encrypted network (e.g., the encrypted network 2 of the first embodiment). The client apparatuses comprise a first client apparatus and one or more second client apparatuses, the first client apparatus stores a first local model, each of the one or more second client apparatuses stores a second local model, the first local model and each of the second local models correspond to a malware type (e.g., the local models M_{A}, M_{B}, M_{C}, and M_{D} of the first embodiment). The machine learning method 400 is performed by the first client apparatus. The machine learning method 400 generates a local model set through the steps S401 to S405, and the local model set can be used to determine the malware.

In the step S401, the first client apparatus receives the second local model corresponding to each of the one or more second client apparatuses from each of the one or more second client apparatuses based on a model update request, wherein the model update request corresponds to the malware type.

Next, in the step S403, the first client apparatus generates a plurality of node sequences based on the first local model and each of the second local models.

Finally, in the step S405, the first client apparatus merges the first local model and each of the second local models based on the node sequences to generate a local model set.

In some embodiments, each of the node sequences comprises a plurality of node items and a characteristic determination value corresponding to each of the node items, and the machine learning method 400 further comprises following steps: the first client apparatus further performs following steps for any two of the node sequences: comparing the node items corresponding to a first node sequence and a second node sequence to generate a similarity; merging the first node sequence and the second node sequence into a new node sequence when determining that the similarity is greater than a first default value, and adjusting the characteristic determination value corresponding to the new node sequence; and retaining the first node sequence and the second node sequence when determining that the similarity is less than a second default value.

In some embodiments, the machine learning method 400 further comprises following steps: deleting at least a part of the node items in the first node sequence and the second node sequence when determining that the similarity is between the first default value and the second default value, merging the first node sequence and the second node sequence into the new node sequence, and adjusting the characteristic determination value corresponding to the new node sequence.

In some embodiments, the machine learning method 400 further comprises following steps: sorting the node items of the first node sequence and the second node sequence based on a feature importance corresponding to each of the node items; deleting the node items that the feature importance is less than a third default value; and merging the first node sequence and the second node sequence into the new node sequence, and adjusting the characteristic determination value corresponding to the new node sequence.

In some embodiments, the machine learning method 400 further comprises following steps: inputting a plurality of local data sets into the local model set to train the local model set; and generating a prediction result based on the local model set, wherein the prediction result comprises a confidence interval.

In some embodiments, the machine learning method 400 further comprises following steps: generating a new local model, wherein the new local model is configured to determine a new malware type.

In some embodiments, the machine learning method 400 further comprises following steps: transmitting the local model set to the one or more second client apparatuses, so that the one or more second client apparatuses update the second local model of each of the one or more second client apparatuses based on the local model set.

In addition to the aforesaid steps, the second embodiment can also execute all the operations and steps of the machine learning system 1 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

It shall be appreciated that in the specification and the claims of the present invention, some words (e.g., the client apparatus, the local model, the default value, and the node sequence) are preceded by terms such as “first” or “second,” and these terms of “first” and “second” are only used to distinguish these different words. For example, the “first” and “second” in the first node sequence and the second node sequence are only used to indicate the node sequence used in different operations.

According to the above descriptions, the machine learning technology (at least includes the system and the method) provided by the present invention transmits a model update request to other client apparatuses in the encrypted network, and receives the local model corresponding to each of the client apparatuses from the client apparatuses. Next, the machine learning technology provided by the present invention generates a plurality of node sequences based on the local models (e.g., the first local model and the second local model). Finally, the machine learning technology provided by the present invention merges the local model to generate a local model set based on the node sequences. The machine learning technology provided by the present invention uses a federated learning sharing model framework to share the learning experience of the local models, and strengthens learning through expert knowledge, integrates the local models of each client apparatus, and enhances the effect of regional joint defense.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A machine learning system, comprising:
a plurality of client apparatuses, being configured to communicate with an encrypted network, wherein the client apparatuses comprise:
a first client apparatus, storing a first local model; and
one or more second client apparatuses, wherein each of the one or more second client apparatuses stores a second local model, the first local model and each of the second local models correspond to a malware type, and the first client apparatus is configured to perform following operations:
transmitting a model update request to the one or more second client apparatuses, wherein the model update request corresponds to the malware type;
receiving the second local model corresponding to each of the one or more second client apparatuses from each of the one or more second client apparatuses;
generating a plurality of node sequences based on the first local model and each of the second local models; and
merging the first local model and each of the second local models based on the node sequences to generate a local model set.

2. The machine learning system of claim 1, wherein each of the node sequences comprises a plurality of node items and a characteristic determination value corresponding to each of the node items, and the first client apparatus further performs following operations for any two of the node sequences:
comparing the node items corresponding to a first node sequence and a second node sequence to generate a similarity;
merging the first node sequence and the second node sequence into a new node sequence when determining that the similarity is greater than a first default value, and adjusting the characteristic determination value corresponding to the new node sequence; and
retaining the first node sequence and the second node sequence when determining that the similarity is less than a second default value.

3. The machine learning system of claim 2, wherein the first client apparatus further performs following operations:
deleting at least a part of the node items in the first node sequence and the second node sequence when determining that the similarity is between the first default value and the second default value, merging the first node sequence and the second node sequence into the new node sequence, and adjusting the characteristic determination value corresponding to the new node sequence.

4. The machine learning system of claim 3, wherein the first client apparatus further performs following operations:
sorting the node items of the first node sequence and the second node sequence based on a feature importance corresponding to each of the node items;
deleting the node items that the feature importance is less than a third default value; and
merging the first node sequence and the second node sequence into the new node sequence, and adjusting the characteristic determination value corresponding to the new node sequence.

5. The machine learning system of claim 1, wherein the first client apparatus further performs following operations:
inputting a plurality of local data sets into the local model set to train the local model set; and
generating a prediction result based on the local model set, wherein the prediction result comprises a confidence interval.

6. The machine learning system of claim 1, wherein the first client apparatus further performs following operations:
generating a new local model, wherein the new local model is configured to determine a new malware type.

7. The machine learning system of claim 1, wherein the first client apparatus further performs following operations:
transmitting the local model set to the one or more second client apparatuses, so that the one or more second client apparatuses update the second local model of each of the one or more second client apparatuses based on the local model set.

8. A machine learning method, being adapted for use in a machine learning system, the machine learning system comprising a plurality of client apparatuses, the client apparatuses being configured to communicate with an encrypted network, wherein the client apparatuses comprise a first client apparatus and one or more second client apparatuses, the first client apparatus stores a first local model, each of the one or more second client apparatuses stores a second local model, the first local model and each of the second local models correspond to a malware type, and the machine learning method is performed by the first client apparatus and comprises following steps:
receiving the second local model corresponding to each of the one or more second client apparatuses from each of the one or more second client apparatuses based on a model update request, wherein the model update request corresponds to the malware type;
generating a plurality of node sequences based on the first local model and each of the second local models; and
merging the first local model and each of the second local models based on the node sequences to generate a local model set.

9. The machine learning method of claim 8, wherein each of the node sequences comprises a plurality of node items and a characteristic determination value corresponding to each of the node items, and the first client apparatus further performs following steps for any two of the node sequences:
comparing the node items corresponding to a first node sequence and a second node sequence to generate a similarity;
merging the first node sequence and the second node sequence into a new node sequence when determining that the similarity is greater than a first default value, and adjusting the characteristic determination value corresponding to the new node sequence; and
retaining the first node sequence and the second node sequence when determining that the similarity is less than a second default value.

10. The machine learning method of claim 9, wherein the first client apparatus further performs following steps:
deleting at least a part of the node items in the first node sequence and the second node sequence when determining that the similarity is between the first default value and the second default value, merging the first node sequence and the second node sequence into the new node sequence, and adjusting the characteristic determination value corresponding to the new node sequence.

11. The machine learning method of claim 10, wherein the first client apparatus further performs following steps:
sorting the node items of the first node sequence and the second node sequence based on a feature importance corresponding to each of the node items;
deleting the node items that the feature importance is less than a third default value; and
merging the first node sequence and the second node sequence into the new node sequence, and adjusting the characteristic determination value corresponding to the new node sequence.

12. The machine learning method of claim 8, wherein the first client apparatus further performs following steps:
inputting a plurality of local data sets into the local model set to train the local model set; and
generating a prediction result based on the local model set, wherein the prediction result comprises a confidence interval.

13. The machine learning method of claim 8, wherein the first client apparatus further performs following steps:
generating a new local model, wherein the new local model is configured to determine a new malware type.

14. The machine learning method of claim 8, wherein the first client apparatus further performs following steps:
transmitting the local model set to the one or more second client apparatuses, so that the one or more second client apparatuses update the second local model of each of the one or more second client apparatuses based on the local model set.
